(19) United States
(12) Patent Application Publication
(10) Pub. No.: US 2008/0026225 A1
(43) Pub. Date: Jan. 31, 2008

(54) Method for producing a wood grain-patterned layer on a surface, a wood grain-patterned layer, and kitchen equipment having a wood grain-patterned surface

(75) Inventor: Jackie Tseng, Chiayi Hsien (TW)

Correspondence Address: SEYFARTH SHAW LLP, 131 S. DEARBORN ST., SUITE2400, CHICAGO, IL, 60603-5803, US

(73) Assignee: SING CHEN INTERNATIONAL CO., LTD.

(21) Appl. No.: 11/494,307

(22) Filed: Jul. 27, 2006

(51) Int. Cl. B32B 15/04; B32B 33/00

(52) U.S. Cl. 428/411.1; 428/457

(57) ABSTRACT

A method for producing a wood grain-patterned layer on an article includes forming a primer layer directly on the surface of the article, painting a woodgrain-pattern on the primer layer, and covering the wood grain-pattern and the primer layer with a transparent wear-resistant coating. A wood grain-patterned layer and kitchen equipment having a wood grain-patterned surface are also disclosed.

### BACKGROUND OF THE INVENTION

1. Field of the Invention

This invention relates to a method for producing a wood grain-patterned layer on an article, more particularly to a method for producing a wood grain-patterned layer on an article by providing a painted wood grain-pattern on a surface of the article. This invention also relates to a wood grain-patterned layer and to kitchen equipment having a wood grain-patterned surface.

2. Description of the Related Art

Barbecue a popular activity when a family reunion or a party with friends is held at home. Since people nowadays tend to pursue living quality enhancement, kitchen equipment, such as an oven, a stove, a roaster, etc., having a relatively appealing appearance is required. For example, it has been proposed to provide monotonous metal surfaces of the kitchen equipment with grain-patterned surfaces so as enhance the appearance of the kitchen equipment.

At present, grain patterns are provided on the surface of the kitchen equipment made of steel, such as ovens, stoves or roasters, etc., through transfer coating techniques. In transfer coating, a grain-patterned layer is transferred from a release paper to a substrate sheet, and the substrate sheet is then adhered to a surface of a piece of kitchen equipment using an adhesive. The grain-patterned layers formed by transfer coating are not resistant to heat and abrasion and are prone to damage or peeling off after a certain period of use.

### SUMMARY OF THE INVENTION

Therefore, the object of the present invention is to provide a method for producing a heat-resisting wood grain-patterned layer on a surface that can alleviate or that is clear of the aforesaid drawback of the prior art.

Another object of this invention is to provide kitchen equipment having a heat-resisting wood grain-patterned surface.

According to one aspect of this invention, a method for producing a wood grain-patterned layer on a surface includes forming a primer layer directly on the surface, painting a wood grain-pattern on the primer layer, and covering the wood grain-pattern and the primer layer with a transparent wear-resistant coating.

According to another aspect of this invention, a wood grain-patterned layer includes a surface, a primer layer formed directly on the surface, a wood grain-pattern painted on the primer layer, and a transparent wear-resistant coating covering the wood grain-pattern and the primer layer.

According to still another aspect of this invention, a piece of kitchen equipment, such as a cabinet that holds an oven, a stove, and/or a roaster, etc., includes a metal body, a primer layer provided directly on a surface of the metal body, a wood grain-pattern painted on the primer layer, and a transparent wear-resistant coating covering the wood grain-pattern.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a flowchart to illustrate consecutive steps of the preferred embodiment of a method for producing a wood grain-patterned layer on an article according to this invention;

FIG. 2 is a fragmentary sectional view of a wood grain-patterned layer produced by the method; and

FIG. 3 is a perspective view to illustrate the preferred embodiment of a piece of kitchen equipment having a wood grain-patterned surface according to this invention.

### DETAILED DESCRIPTION OF THE PREFERRED EMBODIMENTS

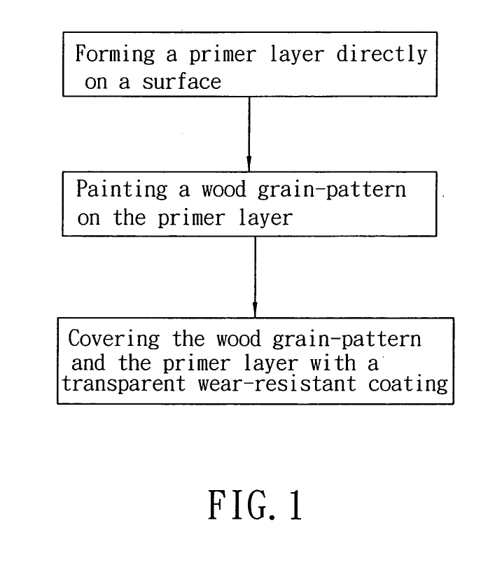

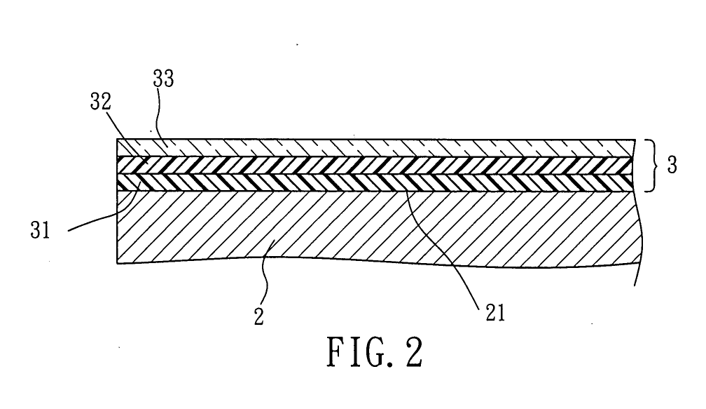

Referring to FIG. 1, the preferred embodiment of a method for producing a wood grain-patterned layer on a surface of an article according to this invention includes forming a primer layer directly on the surface of the article, painting a wood grain-pattern on the primer layer, and covering the wood grain-pattern and the primer layer with a transparent wear-resistant coating. The structure of the wood grain-patterned layer produced by the method is shown in FIG. 2. As shown in FIG. 2, the wood grain-patterned layer 3 according to this invention has a primer layer 31 formed directly on a surface 21 of an article 2, a wood grain-pattern 32 painted on the primer layer 31, and a transparent wear-resistant coating 33 covering the wood grain-pattern 32 and the primer layer 31.

In this embodiment, the article 2 is made of a metal, such as stainless steel. The surface 21 of the article 2 is subjected to a pre-treatment prior to application of the primer layer 31 thereon. The pre-treatment may include but should not be limited to degreasing, cleaning, conditioning, phosphatizing, re-cleaning, baking and drying. The details of the pre-treatment are omitted herein since the pre-treatment does not form any part of this invention and can be readily appreciated by those skilled in the art. While the article 2 is a metal article in this embodiment, the application of the present invention should not be limited thereto. The grain-patterned layer of this invention may be provided on non-metal articles.

The primer layer 31 is formed by spraying a powder coating on the surface 21 of the article 2, followed by baking the powder coating so as to harden the same. The powder coating used in this embodiment is preferably heat-resistant. The powder coating may include a composition containing a resin, a curing agent, a pigment, an additive, and a filler. Since the composition of the powder coating may be any known powder coating suitable for application to a metal surface as a primer, the details thereof are omitted therein. One exemplary composition of the primer layer 31 includes 58.0 wt % of the resin, 3.6 wt % of the curing agent, 10.7 wt % of the pigment, 13.0 wt % of the additive, and 26.4 wt % of the filler, based on total weight of the powder coating.

The baking operation of the powdercoating of the primer layer 31 may be conducted at a temperature ranging from 90 to 150° C. for 20 to 30 minutes. The resulting primer layer 31 thus formed is thermo-resistant.

In this embodiment, the painting operation is conducted by painting the wood grain-pattern 32 directly on the primer layer 31 by hand. Alternatively, a machine, such as a robot, maybe used to paint the woodgrain-pattern 32.

The wood grain-pattern 32 may be formed from any suitable paint that is resistant to heat. The paint may include a resin selected from the group consisting of acrylic resin, melamine resin, epoxy resin, and mixtures thereof, a pigment, a solvent, an additive and a matting agent. A non-limiting example of the paint includes 50.0 wt % of acrylic resin, 17.0 wt % of melamine resin, 5.0 wt % of epoxyresin, 3.0 wt % of the pigment, 20 wt % of the solvent, 1.0 wt % of the additive and 4.0 wt % of the matting agent, based on total weight of the paint.

After the paint is cured, the paint and the primer layer 31 are covered by the transparent wear-resistant coating 33 through the step of spraying a wear-resistant composition on the primer layer 31 and the wood grain-pattern 32, followed by baking the wear-resistant composition so as to cure the same.

The wear-resistant composition may include a clear resin selected from the group consisting of acrylic resin, melamine resin, epoxy resin, and mixtures thereof. The clear resin is mixed with a solvent, an additive, and a matting agent. A non-limiting example of the wear-resistant composition of the transparent wear-resistant coating 33 includes 55.0 wt % of the acrylic resin, 23.0 wt % of the melamine resin, 5.0 wt % of the epoxy resin, 10.0 wt % of the solvent, 2.0 wt % of the matting agent, and 5.0 wt % of the optional additive, based on total weight of the transparent wear-resistant composition.

Preferably, the covering operation of the transparent wear-resistant coating 33 on the wood grain-pattern 32 and the primer layer 31 further includes baking the transparent wear-resistant coating 33 so as to solidify the same. The transparent wear-resistant coating 33 thus formed is thermo-resistant.

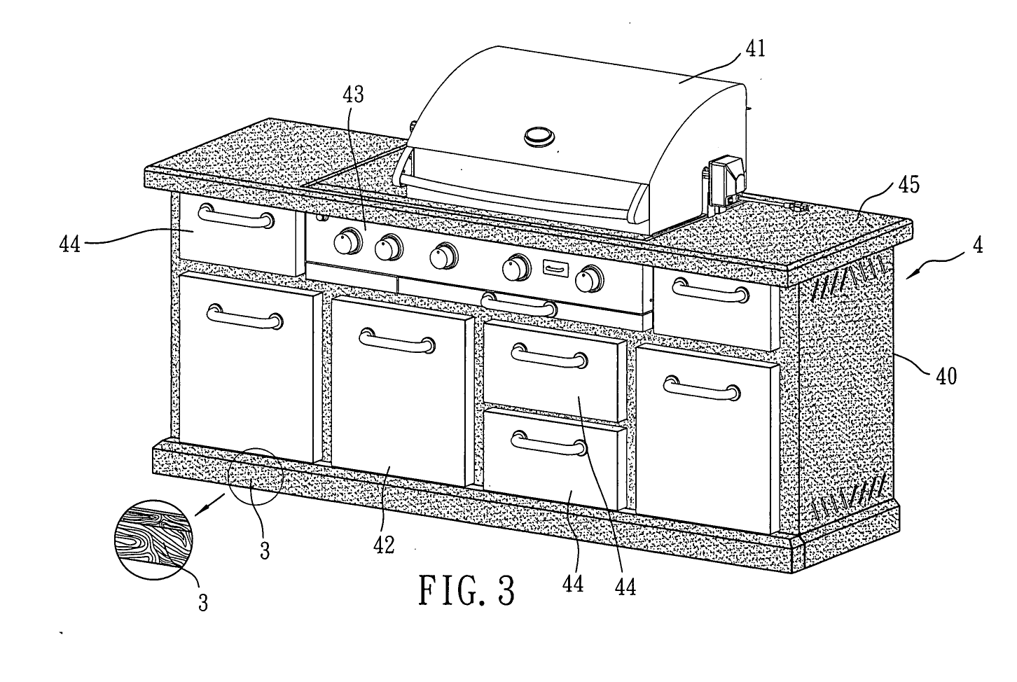

The method for producing a wood grain-patterned layer on an article according to this invention can be applied to kitchen equipment used for heating, cooking, roasting foods, etc. Referring to FIG. 3, a piece of kitchen equipment formed with a woodgrain-patterned layer thereon according to this invention is illustrated. The kitchen equipment 4 shown in FIG. 3 includes a cabinet 40 holding a roaster 41, an oven 42, a controller 43 and drawers 44. The cabinet 40 is made of stainless steel and includes a metal body that has outer surface 45 formed with the wood grain-patterned layer 3 of this invention.

As described above, the wood grain-patterned layer 3 according to this invention includes the primer layer 31, the wood grain-pattern 32 and the transparent wear-resistant coating 33. The primer layer 31 is directly provided on the surface of the kitchen equipment 4, and the wood grain-pattern 32 is painted directly on the primer layer 31. Therefore, there is not any adhesively bonded substrate sheet that is easily peeled off from the kitchen equipment 4. As all of the primer layer 31, the wood grain-pattern 32, and the transparent wear-resistant coating 33 are heat resistant, and in view of the protection provided by the transparent wear-resistant coating 33, the woodgrain-patterned layer 3 according to the invention is durable. Furthermore, because the wood grain-pattern 32 and the transparent wear-resistant coating 33 include matting agents, the wood grain-patterned layer 3 appears like a natural wood surface.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for producing a wood grain-patterned layer on a surface, comprising:
forming a primer layer directly on the surface;
painting a wood grain-pattern on the primer layer; and
covering the wood grain-pattern and the primer layer with a transparent wear-resistant coating.

2. The method of claim 1, further comprising baking the primer layer, the primer layer including a heat-resisting powder coating.

3. The method of claim 2, further comprising baking the transparent wear-resistant coating.

4. The method of claim 3, wherein the wood grain-pattern is painted by hand.

5. The method of claim 4, further comprising pre-treating the surface, the surface being a metal surface.

6. A wood grain-patterned layer comprising:
a surface;
a primer layer directly formed on the surface;
a wood grain-pattern painted on the primer layer; and
a transparent wear-resistant coating covering the wood grain-pattern and the primer layer.

7. The wood grain-patterned layer of claim 6, wherein the primer layer contains a powder coating.

8. The wood grain-patterned layer of claim 7, wherein the transparent wear-resistant coating contains a clear resin, and a matting agent.

9. The wood grain-patterned layer of claim 8, wherein the wood grain-pattern is formed from a paint that contains a matting agent.

10. A piece of kitchen equipment, comprising:
a metal body;
a primer layer provided directly on a surface of the metal body;
a wood grain-pattern painted on the primer layer; and
a transparent wear-resistant coating covering the wood grain-pattern.

11. The piece of kitchen equipment of claim 10, wherein the primer layer contains a powder coating.

12. The piece of kitchen equipment of claim 11, wherein the transparent wear-resistant coating contains a clear resin, and a matting agent.

13. The piece of kitchen equipment of claim 12, wherein the wood grain-pattern is formed from a paint that contains a matting agent.
